(19) United States
(12) Patent Application Publication
(10) Pub. No.: US 2025/0052696 A1
(43) Pub. Date: Feb. 13, 2025

(54) SYSTEM AND METHOD EMPLOYING SINGLE LINE GUIDED SURFACE ELECTROMAGNETIC (EM) WAVES FOR WIRELESS SENSING

(71) Applicant: UNIVERSITY OF PITTSBURGH-OF THE COMMONWEALTH SYSTEM OF HIGHER EDUCATION, PITTSBURGH, PA (US)

(72) Inventors: PAUL R. OHODNICKI, JR., ALLISON PARK, PA (US); JAGANNATH DEVKOTA, PITTSBURGH, PA (US); DAVID GREVE, SEDONA, AZ (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 18/800,357

(22) Filed: Aug. 12, 2024

Related U.S. Application Data
(60) Provisional application No. 63/518,969, filed on Aug. 11, 2023.

(51) Int. Cl. G01N 22/02

(52) U.S. Cl. CPC G01N 22/02

(57) ABSTRACT

Systems and methods using single conductor guided surface electromagnetic (EM) waves to interrogate distant wireless active or passive sensor devices or media surrounding the conductor. The guided waves may be launched on the conductor over a wide frequency range (e.g., MHz to several GHz) using an RF launcher that is connected to an interrogator. Such guided surface EM waves can travel significantly longer distances as compared to the free space propagation of waves because they travel by waveguiding along the conductor surface. Using these waves, power and/or data can be delivered to sensors located on or near the conductor surface, and data can be received from the sensors.

### CROSS REFERENCE TO RELATED APPLICATIONS

This application claims priority to U.S. Provisional Patent Application Ser. No. 63/518,969, filed on Aug. 11, 2023 and titled “System and Method Employing a Goubau Line as an Interrogation and Communication Channel for Wireless Sensors,” the disclosure of which is incorporated herein by reference.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

The disclosed concept relates generally to remote and wireless sensing technologies, and, in particular, to a system and method for interrogating remote, active or passive wireless sensing devices using single line guided surface electromagnetic (EM) waves.

### BACKGROUND OF THE INVENTION

Remote and wireless sensing technology has emerged in recent years in several Industries, including energy, aerospace, and manufacturing, for multi parameter detection and structural health monitoring. Radio frequency (RF) and microwave-based battery free devices such as surface acoustic wave (SAW), surface spoof plasmon (SSP), and other radio frequency identification (RFID) tags are popular wireless sensors due to their high sensitivity, high stability, low maintenance cost, and design flexibility for targeted applications. Despite several advantages, the short communication range of these passive sensors imposes a challenge in using them for large systems and/or harsh condition sensing, such as in pipelines, power plants, and well-bores. In addition, electromagnetic waves attenuate too rapidly in free space to interrogate sensors over the long distances encountered in the oil and gas industry, water supply pipes, or even heating, ventilation, and air conditioning (HVAC) systems. Also, lossy environments such as high temperature, radiation, or subsurface conditions, cause high attenuation that severely limits the potential for free space wireless power and signal delivery over significant distances. Lately, data security is becoming a concern in several industries that utilize wireless networks.

### SUMMARY OF THE INVENTION

In one embodiment, a wireless sensing system is provided that includes a single conductor, an RF signal generator structured and configured to generate an RF interrogation signal, an RF launcher coupled to a first end of the conductor, the RF launcher being structured and configured to receive the RF interrogation signal and provide the RF interrogation signal to the conductor, the conductor being structured and configured to communicate the RF interrogation signal on the conductor as a number of first electromagnetic (EM) waves propagated on an outer surface of the conductor, an interrogator coupled to the RF launcher, and a wireless sensor located remotely from the RF launcher and positioned near the conductor. The wireless sensor is structured and configured to receive the RF interrogation signal based on the number of first EM waves and in response to the RF interrogation signal generate a backscattered RF signal, wherein the conductor is structured and configured to propagate a number of second EM waves on the outer surface of the conductor based on the backscattered RF signal, and wherein the RF launcher is structured and configured to receive the number of second EM waves and provide the backscattered RF signal to the interrogator based on the number of second EM waves.

In another embodiment, a wireless sensing method is provided that includes receiving an RF interrogation signal in an RF launcher coupled to a first end of a single conductor and providing the RF integration signal to the conductor, communicating the RF interrogation signal on the conductor as a number of first electromagnetic (EM) waves propagated on an outer surface of the conductor, receiving the RF interrogation signal in a wireless sensor located remotely from the RF and positioned near the conductor based on the number of first EM waves and based on the RF interrogation signal generating a backscattered RF signal, propagating a number of second EM waves on the outer surface of the conductor based on the backscattered RF signal, and receiving the backscattered RF signal in an interrogator based on the number of second EM waves.

In a further embodiment, a sensing system is provided that includes a single conductor provided in a surrounding medium, an RF signal generator structured and configured to generate an RF interrogation signal, an RF launcher coupled to a first end of the conductor, the RF launcher being structured and configured to receive the RF interrogation signal and provide the RF interrogation signal to the conductor, the conductor being structured and configured to communicate the RF interrogation signal on the conductor as a number of first electromagnetic (EM) waves propagated on an outer surface of the conductor, and an interrogator coupled to the RF launcher. In this embodiment, the surrounding medium is structured and configured to receive the RF interrogation signal based on the number of first EM waves and in response to the RF interrogation signal cause a backscattered RF signal to be generated, the backscattered RF signal being generated in response to a local disturbance in a dielectric property of the surrounding medium, wherein the conductor is structured and configured to propagate a number of second EM waves on the outer surface of the conductor in response to the backscattered RF signal, and wherein the RF launcher is structured and configured to receive the number of second EM waves and provide the backscattered RF signal to the interrogator based on the number of second EM waves.

In still a further embodiment, a wireless sensing method is provided that includes receiving an RF interrogation signal in an RF launcher coupled to a first end of a single conductor provided in a surrounding medium and providing the RF integration signal to the conductor, communicating the RF interrogation signal on the conductor as a number of first electromagnetic (EM) waves propagated on an outer surface of the conductor, wherein the RF interrogation signal is received in the surrounding medium based on the number of first EM waves, wherein and in response to the RF interrogation signal a backscattered RF signal is generated, the backscattered RF signal being generated in response to a local disturbance in a dielectric property of the surrounding medium, propagating a number of second EM waves on the outer surface of the conductor in response to the backscattered RF signal, and receiving the backscattered RF signal in an interrogator based on the number of second EM waves and identifying a crack, void, localized corrosion or localized degradation in the surrounding media based on the backscattered RF signal.

### BRIEF DESCRIPTION OF THE DRAWINGS

A full understanding of the invention can be gained from the following description of the preferred embodiments when read in conjunction with the accompanying drawings in which:

FIG. 1 is a schematic block diagram of a sensing system according to a non-limiting exemplary embodiment of the disclosed concept;

FIG. 2 is a schematic block diagram of a sensing system according to an alternative non-limiting exemplary embodiment of the disclosed concept;

FIG. 3 is a schematic block diagram of a sensing system according to another alternative non-limiting exemplary embodiment of the disclosed concept;

FIG. 4 is a schematic block diagram of a sensing system according to yet another alternative non-limiting exemplary embodiment of the disclosed concept;

FIG. 5 is a schematic diagram of an exemplary full horn launcher according to a non-limiting exemplary embodiment of the disclosed concept;

FIG. 6 is a schematic diagram of an exemplary partial horn launcher according to a non-limiting exemplary embodiment of the disclosed concept; and

FIG. 7 is a schematic diagram of an exemplary partial horn launcher according to another non-limiting exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of disclosed concept.

The disclosed concept, as described herein, provides for the use of low loss, single line guided surface electromagnetic (EM) waves (commonly known as Goubau waves) to interrogate distant wireless active or passive sensor devices. The guided waves are launched on a solid or hollow metallic conductor, such as a rod or tubular structure with or without a dielectric coating, over a wide frequency range (e.g., MHz to several GHz) using an RF launcher, such as, without limitation, a horn launcher or a monopole launcher, that is connected to an interrogator, such as a vector network analyzer, via a coaxial cable or similar wired connection. Such guided surface EM waves can travel significantly longer distances as compared to the free space propagation of waves because they travel by waveguiding along the conductor surface. Using these waves, power can be delivered to sensors located on or near the conductor surface.

The disclosed concept may be used to power and interrogate a wide variety of active or passive wireless sensors, such as, without limitation, SAW devices, SSP devices, or RFID tags, that can be interrogated in back scattered mode for real time monitoring of multiple parameters including temperature, pressure, strain, dielectric constant, pH, corrosion level, and gas concentrations. The data from the sensors may be processed using advanced data analytics and machine learning tools for real-time monitoring and identification of failures or incidents before they occur. The technique of the disclosed concept not only increases the interrogation distance of wireless sensors, but also allows for distributed interrogation and/or secure data transfer. In addition to sensor interrogation, the propagation of the Goubau waves is sensitive to the dielectric properties of the surrounding media. As a result, the dielectric properties of the surrounding media can be interrogated in a distributed fashion in order to detect and identify cracks, voids, or localized corrosion and degradation in the surrounding media that result in a local variation or disturbance in dielectric constant. Such distributed dielectric measurements can also be utilized in the context of emerging concepts in non-destructive evaluation methods and techniques using microwave frequency electromagnetic radiation. Many systems including energy infrastructures, such as oil and gas pipelines, bore-hole pipes, water supply pipes, power generation units, HVAC systems, and others that use metallic tubular structures in ambient or harsh condition may benefit from the technology of the disclosed concept as described herein.

The disclosed concept thus provides a distributed electromagnetic interrogation scheme along with enabling technologies by leveraging guided EM surface waves propagating along a single conductor. The waveguiding conductor and the surface wave launcher designs may vary within the scope of the disclosed concept. Common waveguiding conductor geometries include bare or dielectric-coated cylindrical rods, hollow pipes, and/or corrugated planar lines, and common launchers include horn structures and monopole launcher structures. Of particular interest is the ability of RF/microwave signals to propagate for relatively long distances along these conductors such that they may overcome the limitations of EM-based passive sensors caused by short interrogation distances, which is typical when free space radiation is used.

The disclosed concept envisions a number of different, non-limiting exemplary embodiments of an integrated diagnostic and monitoring system that leverages the basic advantages just described. One embodiment involves the design and integration of RF launchers to transform EM wave propagation from a conventional coaxial transmission line to single conductors. The transformed waves are surface waves (i.e., Goubau waves) around the conductor that propagate along its length. The conductor may be a cylindrical rod or pipe (that may or may not have a dielectric coating), and the particular conductor structure is application specific. The launcher is, in one particular embodiment, a horn-type antenna with a full or partial cone as desired for an application, and can be integrated to an end or the middle of the single conductor.

Another embodiment involves the use of the guided single line surface waves along a cylindrical structure to deliver RF power to the sensor devices on or nearby the conductor to enable distributed sensing and secure transfer of sensor data back to a reader. Yet another embodiment involves the design and development of wireless sensor devices and their deployment on or near a cylindrical metallic structure carrying the Goubau waves for targeted real time monitoring applications. The sensor devices may include RF and microwave-based sensors such as SAW devices, SSP devices, and RFID tags, that can be designed and functionalized for multiparameter sensing. The response of such sensors can be read in backscattered mode using the same surface waves so that no additional circuitry is required. These devices can be designed and deployed for monitoring the structural health and other relevant parameters of a system, such as leaks, gas species, humidity, and temperature, to name a few. Still another embodiment involves the distributed interrogation of local media dielectric properties, such as, without limitation, refractory materials surrounding metallic tubular structures in high temperature applications, wellbore cements surrounding metallic casings, and containment system concrete in nuclear applications. The Goubau waves can be launched on conducting surfaces as described and may be combined with advanced interrogation methods, such as time domain reflectometry (TDR), to identify local variations in dielectric properties that are indicative of corrosion, voids, cracks, or other degradation. The details of the penetration depth of the Goubau wave as well as the propagation distance can be optimized based upon the excitation/launcher design.

The disclosed concept thus allows for the distributed interrogation of distant wireless sensors, active or passive, that operate in backscattered modes and the secure transmission of sensor data using guided waves. This would enable wireless sensors to be readily deployed on long metallic structures and nearby locations that were previously assumed to be unsuitable, and thus allows for the secure transmission of sensor data that would not otherwise be possible in wireless mode. The described technology also allows for the interrogation of the sensor devices with variations in both operation frequency and functionality using a single guided line. Example of sensing technologies that could be integrated using these guided waves include SAW sensors, solid state sensors (SiC, CMOS, GaAs etc.), SSP devices, and other microwave resonant sensors that can be designed for real time sensing of gases, pH, chemical species, condensed water, corrosion onset, current, electrical or magnetic field, temperature, and/or pressure at distant locations where free space penetration of EM waves is not possible. This technique also allows for the secure transmission of the sensor data from a remote location that would not otherwise be possible in wireless transmission. In addition, the disclosed technology provides a flexible way to monitor the dielectric properties of the medium, such as concrete, rocks, and cements, around a metal cylinder or other conducting surface in which the wave propagates. By monitoring these properties, structural health monitoring can also be accomplished. Thus, the disclosed interrogation and data transmission technologies in combination with advanced data analytics methodologies enable secure and distributed wireless sensing systems for asset health monitoring in energy, aerospace, other industries.

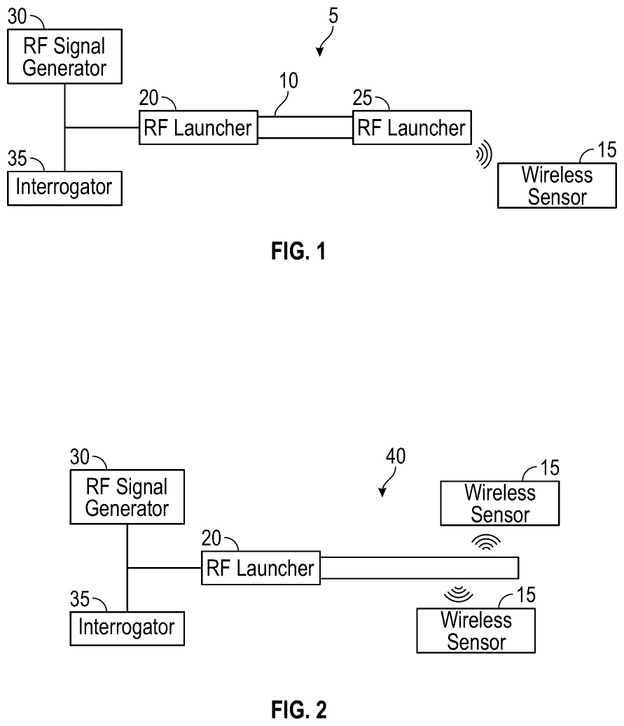

FIG. 1 is a schematic block diagram of a sensing system 5 according to a non-limiting exemplary embodiment of the disclosed concept. Sensing system 5 is a system in which a single conductor 10, as described herein, is used to propagate guided surface EM waves (i.e., Goubau waves) for purposes of interrogating a number of remote wireless active or passive sensor devices, such as wireless sensor 15 shown in FIG. 1. As seen in FIG. 1, a first RF launcher 20 is operatively coupled to a first terminal end of conductor 10, and a second a second RF launcher 25 is operatively coupled to a second terminal end of conductor 10 opposite the first terminal end of conductor 10. In the exemplary embodiment, first RF launcher 20 and second RF launcher 25 are each a horn launcher, although it will be appreciated that this is meant to be exemplary only and that first RF launcher 20 and/or second RF launcher 25 may be another type of RF launcher, such as a monopole launcher. An RF signal generator 30 capable of generating an RF signal over a wide frequency range (e.g., MHz to several GHz in the exemplary embodiment) is coupled to an input end of RF launcher 20. In addition, an interrogator 35 is also coupled to the input end of RF launcher 20. In the exemplary embodiment, interrogator 35 is a vector network analyzer structured and is configured to receive and process backscattered signals from wireless sensors such as wireless sensor 15. Also in the exemplary embodiment, RF signal generator 30 and interrogator 35 are coupled to RF launcher 20 by a coaxial cable, although other suitable connection schemes (wired or wireless) may also be used. In some contexts, RF signal generator 30 and interrogator 35 can together be referred to as an interrogation unit, and can be provided in the same or separate devices. In addition, as seen in FIG. 1, wireless sensor 15 is positioned near second RF launcher 25 such that second RF launcher 25 is able to make a wireless connection to wireless sensor 15. Although a single wireless sensor 15 is shown in FIG. 1, it will be appreciated that a number of additional wireless sensors 15 may be positioned near second RF launcher 25 for purposes of interrogating such additional wireless sensors according to the disclosed concept.

In operation, in order to interrogate wireless sensor 15, RF signal generator 30 generates an RF interrogation signal of a desired frequency that in turn is coupled to first RF launcher 20. In response, first RF launcher 20 will cause EM waves based on the RF interrogation signal to be provided to the first end of conductor 10. The provided EM waves will propagate along the outer surface of conductor 10 until they reach second RF launcher 25. RF launcher 25, acting as a transmit antenna, will then wirelessly transmit the received EM waves as a local RF signal that can be received by wireless sensor 25. In the case where wireless sensor 15 is a passive sensor, the received local RF signal will be used to power wireless sensor 15 so that a sensor signal (e.g., indicating a measured parameter or the like) can be generated and transmitted from wireless sensor 15 as a backscattered RF signal. If wireless sensor is an active sensor, the received local RF signal does not need to be used for power, and instead is used to trigger interrogation of wireless sensor 15 and the generation of the backscattered RF signal. The backscattered RF signal is then received by second RF launcher 25 and provided to conductor 10. The received backscattered RF signal will then be caused to be introduced to conductor 10 and transmitted along the outer surface of conduct 10 as surface EM waves. The EM waves composing the backscattered RF signal are received by first RF launcher 20 and thereafter are provided to interrogator 35 for processing and analysis by interrogator 35.

Conductor 10 may, in some embodiments, be a solid cylindrical conductor, such as a wire or rod, or alternatively may be a hollow conductor, such as pipe that may already be present in the environment in which sensing system 5 is to be implemented.

When the pipe size becomes bigger and approaches free space wavelength of the wave propagating on it, launching a wave becomes more complicated because eventually the launcher needs to be fed at a single place. Also, higher order modes of the electromagnetic waves become possible. Thus, specially designed launchers are advantageous to minimize the potential issues due to phase shifts around a bigger pipe. These issues arise when the “size” becomes an appreciable fraction of a wavelength. The present inventors' estimation is that this issue arises when the conductor diameter ˜0.1 times the free space wavelength. Any diameter above this value would be considered a “large” pipe.

In an experiment conducted by the present inventors, they have demonstrated the launching and propagation of 434 MHz EM waves on 4″ diameter pipe and have shown the interrogation of passive sensors using these waves. In this case, the diameter/free space wavelength ˜0.15. In the same setup, the present inventors have also demonstrated the launching of 868 MHz waves and successfully interrogated passive sensors. In this case, the diameter/free space wavelength ˜0.3.

Thus, in the exemplary embodiment, conductor 10 may be a “small diameter” solid or hollow conductor, meaning it has an outer diameter that is less than ˜0.1 times the free space wavelength of the wave propagating on it. Alternatively, conductor 10 may be a “large diameter” solid or hollow conductor, meaning it has an outer radius that is greater than or equal to ˜0.1 times the free space wavelength of the wave propagating on it. In one exemplary embodiment, large radius conductors 10 have an outer radius of 0.1m or greater. As used herein “˜” or “approximately” shall mean±10% of a given value.

FIG. 2 is a schematic block diagram of a sensing system 40 according to an alternative non-limiting exemplary embodiment of the disclosed concept. Sensing system 40 is similar to sensing system 5, and like parts are labelled with like reference numerals. In sensing system 40, however, the second RF launcher 25 is not provided, and a number of wireless sensors 15 are positioned near conductor 10 at various positions along the length thereof. In operation, EM waves are generated and launched onto the outer surface of conductor 10 in the same manner as in sensing system 5. In sensing system 40, as a result of the surface EM waves, local RF interrogation signals will be radiated from conductor 10 and received by wireless sensor or sensors 15 in order to interrogate wireless sensor or sensor 15 to cause them to generate the backscattered RF signals as described herein. Those backscattered RF signals are then coupled back onto conductor 10 and propagate as surface EM waves back to RF launcher 20 and ultimately to interrogator 35.

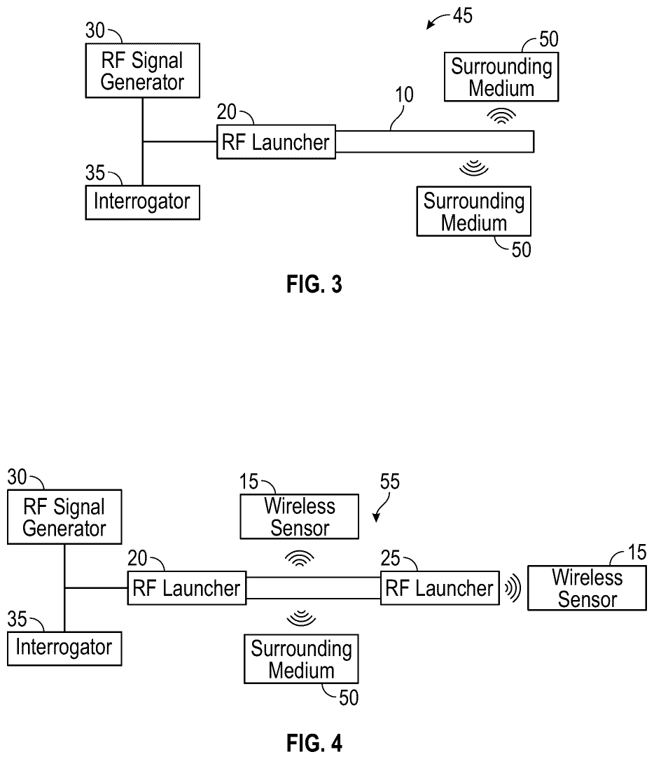

FIG. 3 is a schematic block diagram of a sensing system 45 according to another alternative non-limiting exemplary embodiment of the disclosed concept. Sensing system 45 is similar to sensing system 40, and like parts are labelled with like reference numerals. However, sensing system 45 is structured and configured to measure the dielectric properties of the media 50 surrounding conductor 10 in a distributed fashion in order to detect and identify cracks, voids, localized corrosion and/or localized degradation in the surrounding media 50 that result in a local variation in dielectric constant of surrounding media 50. In operation, EM waves are generated and launched onto the outer surface of conductor 10 in the same manner as in sensing systems 5 and 40. As a result, local RF signals will be radiated from conductor 10 along the length thereof and will be received by surrounding media 50. If cracks, voids, localized corrosion and/or degradation are present in surrounding media 50, they/it will cause signals to be backscattered back onto the outer surface of conductor 10. Those backscattered RF signals will propagate as surface EM waves back to RF launcher 20 and ultimately to interrogator 35 so that they can be analyzed to identify the cracks, voids, localized corrosion and/or localized degradation that caused the backscatter.

FIG. 4 is a schematic block diagram of a sensing system 55 according to yet another alternative non-limiting exemplary embodiment of the disclosed concept. As seen in FIG. 4, sensing system 55 employs one or more components/concepts from sensing systems 5, 40, and 45. As a result, in sensing system 55, the surface EM waves that are propagated along conductor 10 can be used to interrogate and/or gather information from wireless sensor(s) 15 located near second RF launcher 25, wireless sensor(s) 15 positioned near and along the length of conductor 10 and/or from the media 50 surrounding conductor 10.

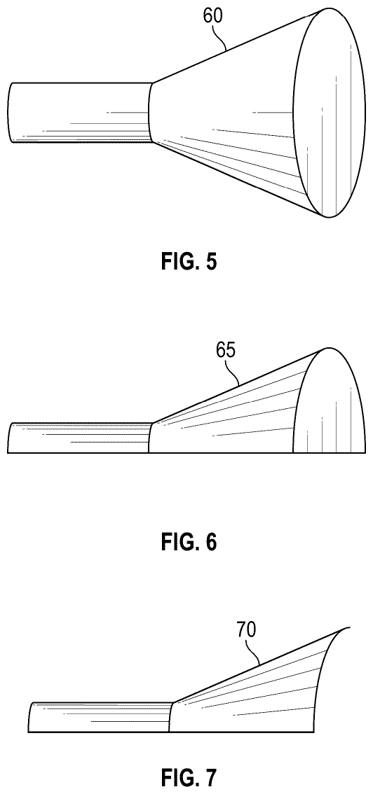

As noted elsewhere herein, RF launcher 20 and/or RF launcher 25 can be a horn launcher. An exemplary full horn launcher 60 (having a full cone) is shown in FIG. 5, an exemplary partial horn launcher 65 (having a half cone) is shown in FIG. 6, and an exemplary partial horn launcher 70 (having a quarter cone) is shown in FIG. 7. Any of these horn launchers 60, 65 and 70 can be used to implement RF launcher 20 and/or RF launcher 25.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A wireless sensing system, comprising:
a single conductor;
an RF signal generator structured and configured to generate an RF interrogation signal;
an RF launcher coupled to a first end of the conductor, the RF launcher being structured and configured to receive the RF interrogation signal and provide the RF interrogation signal to the conductor, the conductor being structured and configured to communicate the RF interrogation signal on the conductor as a number of first electromagnetic (EM) waves propagated on an outer surface of the conductor;
an interrogator coupled to the RF launcher; and
a wireless sensor located remotely from the RF launcher and positioned near the conductor, the wireless sensor being structured and configured to receive the RF interrogation signal based on the number of first EM waves and in response to the RF interrogation signal generate a backscattered RF signal, wherein the conductor is structured and configured to propagate a number of second EM waves on the outer surface of the conductor based on the backscattered RF signal, and wherein the RF launcher is structured and configured to receive the number of second EM waves and provide the backscattered RF signal to the interrogator based on the number of second EM waves.

2. The wireless sensing system according to claim 1, further comprising a second RF launcher coupled to a second end of the conductor opposite the first end, the wireless sensor being positioned near the second RF launcher, the second RF launcher being structured and configured to transmit the RF interrogation signal based on the number of first EM waves and receive the backscattered RF signal and provide the backscattered RF signal to the second end of the conductor.

3. The wireless sensing system according to claim 1, wherein the wireless sensor is positioned along a length of the conductor at a location between the first end of the conductor and a second end of the conductor opposite the first end.

4. The wireless sensing system according to claim 1, wherein the RF signal generator and the interrogator are part of a single device.

5. The wireless sensing system according to claim 1, wherein the RF signal generator and the interrogator are part of separate devices.

6. The wireless sensing system according to claim 1, wherein the interrogator is a vector network analyzer.

7. The wireless sensing system according to claim 1, wherein the RF launcher is a horn launcher.

8. The wireless sensing system according to claim 7, wherein the horn launcher is a full horn launcher having a full cone.

9. The wireless sensing system according to claim 7, wherein the horn launcher is a partial horn launcher having less than a full cone.

10. The wireless sensing system according to claim 9, wherein the partial horn launcher has a half cone.

11. The wireless sensing system according to claim 9, wherein the partial horn launcher has a quarter cone.

12. The wireless sensing system according to claim 1, wherein the conductor is a solid conductor.

13. The wireless sensing system according to claim 1, wherein the conductor is a hollow conductor.

14. The wireless sensing system according to claim 13, wherein the conductor is a pipeline.

15. The wireless sensing system according to claim 1, wherein the conductor is a large diameter conductor having an outer diameter that is ˜0.1 times the free space wavelength of the wave propagating on the conductor.

16. A wireless sensing method, comprising:
receiving an RF interrogation signal in an RF launcher coupled to a first end of a single conductor and providing the RF integration signal to the conductor;
communicating the RF interrogation signal on the conductor as a number of first electromagnetic (EM) waves propagated on an outer surface of the conductor;
receiving the RF interrogation signal in a wireless sensor located remotely from the RF and positioned near the conductor based on the number of first EM waves and in response to the RF interrogation signal generating a backscattered RF signal;
propagating a number of second EM waves on the outer surface of the conductor based on the backscattered RF signal; and
receiving the backscattered RF signal in an interrogator based on the number of second EM waves.

17. The wireless sensing method according to claim 16, wherein a second RF launcher is coupled to a second end of the conductor opposite the first end, the wireless sensor being positioned near the second RF launcher, the second RF launcher being structured and configured to transmit the RF interrogation signal based on the number of first EM waves and receive the backscattered RF signal and provide the backscattered RF signal to the second end of the conductor.

18. The wireless sensing method according to claim 16, wherein the wireless sensor is positioned along a length of the conductor at a location between the first end of the conductor and a second end of the conductor opposite the first end.

19. The wireless sensing method according to claim 16, wherein the RF launcher is a full horn launcher having a full cone.

20. The wireless sensing method according to claim 16, wherein the RF launcher is a partial horn launcher having a half cone or a quarter cone.

21. The wireless sensing method according to claim 16, wherein the conductor is a solid conductor.

22. The wireless sensing method according to claim 16, wherein the conductor is a hollow conductor.

23. The wireless sensing method according to claim 22, wherein the conductor is a pipeline.

24. The wireless sensing system according to claim 16, wherein the conductor is a large diameter conductor having an outer diameter that is ˜0.1 times the free space wavelength of the wave propagating on the conductor.

25. A sensing system, comprising:
a single conductor provided in a surrounding medium;
an RF signal generator structured and configured to generate an RF interrogation signal;
an RF launcher coupled to a first end of the conductor, the RF launcher being structured and configured to receive the RF interrogation signal and provide the RF interrogation signal to the conductor, the conductor being structured and configured to communicate the RF interrogation signal on the conductor as a number of first electromagnetic (EM) waves propagated on an outer surface of the conductor; and
an interrogator coupled to the RF launcher, the surrounding medium being structured and configured to receive the RF interrogation signal based on the number of first EM waves and in response to the RF interrogation signal cause a backscattered RF signal to be generated, the backscattered RF signal being generated in response to a local disturbance in a dielectric property of the surrounding medium, wherein the conductor is structured and configured to propagate a number of second EM waves on the outer surface of the conductor based on the backscattered RF signal, and wherein the RF launcher is structured and configured to receive the number of second EM waves and provide the backscattered RF signal to the interrogator based on the number of second EM waves.

26. The sensing system according to claim 25, wherein the interrogator is structured and configured to identify a crack, void, localized corrosion or localized degradation in the surrounding media based on the backscattered RF signal.

27. The sensing system according to claim 25, wherein the RF signal generator and the interrogator are part of a single device.

28. The sensing system according to claim 25, wherein the RF signal generator and the interrogator are part of separate devices.

29. The sensing system according to claim 25, wherein the interrogator is a vector network analyzer.

30. The sensing system according to claim 25, wherein the RF launcher is a horn launcher.

31. The sensing system according to claim 30, wherein the horn launcher is a full horn launcher having a full cone.

32. The sensing system according to claim 30, wherein the horn launcher is a partial horn launcher having less than a full cone.

33. The sensing system according to claim 32, wherein the partial horn launcher has a half cone.

34. The sensing system according to claim 32, wherein the partial horn launcher has a quarter cone.

35. The sensing system according to claim 25, wherein the conductor is a solid conductor.

36. The sensing system according to claim 25, wherein the conductor is a hollow conductor.

37. The sensing system according to claim 36, wherein the conductor is a pipeline.

38. The sensing system according to claim 25, wherein the conductor is a large diameter conductor having an outer diameter that is ˜0.1 times the free space wavelength of the wave propagating on the conductor.

39. A wireless sensing method, comprising:
receiving an RF interrogation signal in an RF launcher coupled to a first end of a single conductor provided in a surrounding medium and providing the RF integration signal to the conductor;
communicating the RF interrogation signal on the conductor as a number of first electromagnetic (EM) waves propagated on an outer surface of the conductor, wherein the RF interrogation signal is received in the surrounding medium based on the number of first EM waves, wherein in response to the RF interrogation signal a backscattered RF signal is generated, the backscattered RF signal being generated in response to a local disturbance in a dielectric property of the surrounding medium;
propagating a number of second EM waves on the outer surface of the conductor based on the backscattered RF signal; and
receiving the backscattered RF signal in an interrogator based on the number of second EM waves and identifying a crack, void, localized corrosion or localized degradation in the surrounding media based on the backscattered RF signal.

40. The sensing method according to claim 39, wherein the RF launcher is a full horn launcher having a full cone.

41. The sensing method according to claim 39, wherein the RF launcher is a partial horn launcher having a half cone or a quarter cone.

42. The sensing method according to claim 39, wherein the conductor is a solid conductor.

43. The sensing method according to claim 39, wherein the conductor is a hollow conductor.

44. The sensing method according to claim 43, wherein the conductor is a pipeline.

45. The sensing system according to claim 39, wherein the conductor is a large diameter conductor having an outer diameter that is ˜0.1 times the free space wavelength of the wave propagating on the conductor.
